(19) United States
(12) Patent Application Publication
(10) Pub. No.: US 2002/0190570 A1
(43) Pub. Date: Dec. 19, 2002

(54) Axle extension device

(76) Inventor: Dave J. Gorges, Colwich, KS (US)

Correspondence Address: HARSHAW RESEARCH INCORPORATED, P O BOX 418, OTTAWA, KS, 66067, US

(21) Appl. No.: 09/884,690

(22) Filed: Jun. 19, 2001

(51) Int. Cl. B60B 3/16

(52) U.S. Cl. 301/35.629

(57) ABSTRACT

An axle extension device for broadening the wheel base of a vehicle includes a circular extender plate having a plurality of bores adapted to receive the mounting studs of a vehicle hub therethrough. Nuts may be threadably attached to ends of respective mounting studs to secure the plate to the vehicle hub. A number of stud bolts equal to the number of mounting studs extend outwardly from the extender plate and may selectably extend through corresponding holes of a hub of a vehicle tire/wheel combination. The wheel may be secured thereto with lug nuts. The stud bolts are configured such that a tire/wheel combination configured for attachment to the vehicle mounting studs is configured for attachment to the extender plate. The extender plate has a thickness such that a tire/wheel combination attached thereto is displaced from the vehicle's wheel hub so the vehicle's wheel base is broadened.

### BACKGROUND OF THE INVENTION

This invention relates generally to wheel mounting devices and, more particularly, to an axle extension device which broadens the wheel base of a vehicle and enables the original tires and wheels to be mounted thereto.

Various devices have been proposed in the art for adapting a vehicle wheel hub to receive a wheel thereon having a bolt pattern different from that of the vehicle wheel hub itself. For example, a wheel adapter may allow a vehicle owner to exchange a five-bolt, four inch bolt circle wheel for a five-bolt, five inch bolt circle wheel. Or, another properly configured adapter may allow a vehicle owner to exchange a five-bolt wheel for an eight-bolt wheel, etc. Although assumably effective for their intended purposes, the existing devices do not provide a means for conveniently extending the length of an axle while still enabling the axle to receive conventional vehicle wheels thereon and, therefore, to extend the wheel base of the vehicle.

Therefore, it is desirable to have an axle extension device which may be coupled to a vehicle wheel hub for extending the corresponding axle and widening the wheel base of the vehicle. Further, it is desirable to have an axle extension device that allows the vehicle's stock wheels to be mounted thereto.

### SUMMARY OF THE INVENTION

An axle extension device according to the present invention includes a circular axle extender plate defining a plurality of bores therethrough arranged in a bolt circle and adapted to respectively receive the mounting studs of a vehicle wheel hub therethrough. A plurality of nuts having threads complementary to those of the mounting studs may be used to secure the extender plate to the vehicle wheel hub. The extender plate further includes a plurality of stud bolts arranged in a bolt circle with each stud bolt positioned between a pair of extender plate bores. The stud bolts are constructed in a manner substantially similar to the mounting studs of the vehicle wheel hub in that the hub of a vehicle wheel may be received thereon and secured thereto with conventional lug nuts. The extender plate presents a thickness such that a wheel attached thereto is offset about ½″ to 3 inches from the actual vehicle wheel hub.

Therefore, a general object of the present invention is to provide an axle extension device which increases the wheel base of a vehicle.

Another object of this invention is to provide an axle extension device, as aforesaid, which allows wheels having the same bolt configuration as the vehicle wheel hub to be mounted to the extender plate.

Still another object of this invention is to provide an axle extension device, as aforesaid, having a predetermined thickness such that a wheel mounted thereto is offset a corresponding distance from the vehicle wheel hub.

A further object of this invention is to provide an axle extension device, as aforesaid, which improves vehicle handling and control when driving along curves and corners.

A still further object of this invention is to provide an axle extension device, as aforesaid, which provides an aesthetically pleasing custom appearance to tires and wheels mounted thereto.

Other objects and advantages of this invention will become apparent from the following description taken in connection with the accompanying drawings, wherein is set forth by way of illustration and example, an embodiment of this invention.

### BRIEF DESCRIPTION OF THE DRAWINGS

FIG. 1 is an exploded perspective view of an axle extension device according to the present invention mounted to a vehicle wheel hub;

FIG. 2 is a front view of the extension device as in FIG. 1;

FIG. 3 is a sectional view of the extension device taken along line 3-3 of FIG. 2; and

FIG. 4 is a perspective view of the extension device as in FIG. 1 mounted to a vehicle wheel hub.

### DESCRIPTION OF THE PREFERRED EMBODIMENT

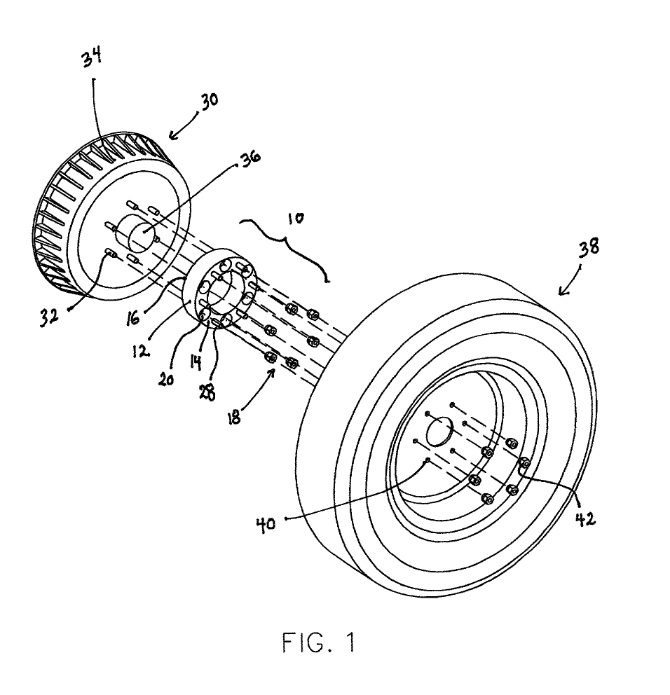

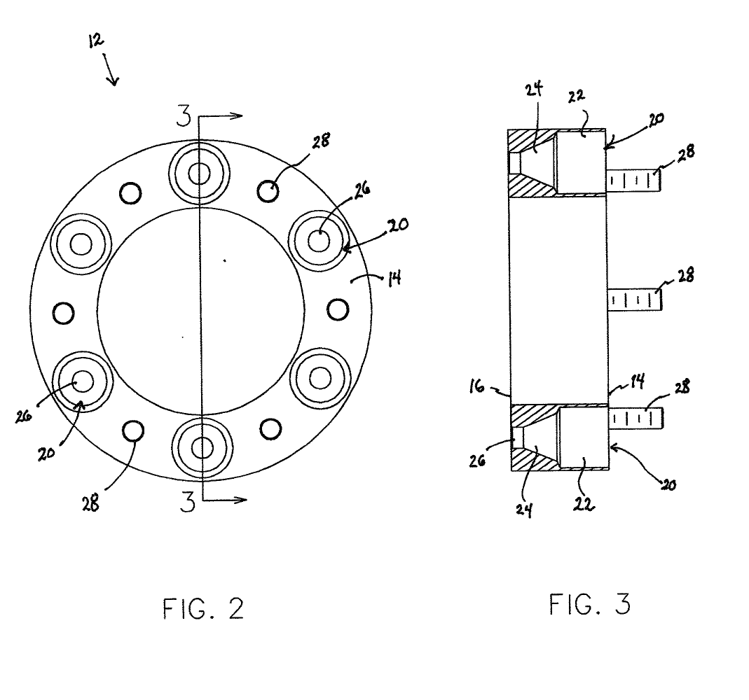

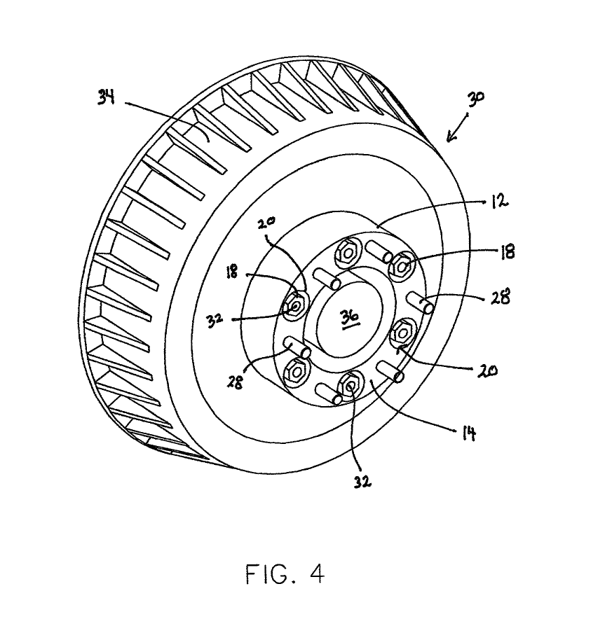

An axle extension device 10 according to a preferred embodiment of the present invention will now be described in detail with reference to FIGS. 1 through 4 of the accompanying drawings. The axle extension device 10 includes an extender plate 12 having a circular configuration with a first (front) side 14 and a second (back) side 16 (FIG. 1). The extender plate 12 defines a cylindrically-shaped open center having a diameter large enough that the plate may be received on the axle 36 of a motor vehicle (FIG. 4). The extender plate 12 further defines a plurality of bores 20 extending between first 14 and second 16 sides and arranged in a bolt circle.

The extender plate 12 is configured to be mounted to a vehicle wheel hub 30. A conventional vehicle wheel hub 30 includes a plurality of threaded mounting studs 32 extending outwardly from a brake drum 34 or disk brake assembly and arranged in a bolt circle, the brake drum being mounted to a corresponding axle 36 for rotation therewith (FIGS. 1 and 3). In the present invention, each extender plate 12 is preferably constructed for use with a particular model of vehicle having a particular wheel hub configuration. The diameter, number, and configuration of the bolt circle of extender plate bores 20 is equal to the diameter, number, and configuration of mounting studs 32 of a corresponding vehicle wheel hub 30 such that the mounting studs 32 may be respectively received through the extender plate bores 20 (FIG. 1). A plurality of nuts 18 having threads complementary to respective mounting studs 32 may be threadably coupled to ends thereof for securing the extender plate 12 to the vehicle wheel hub 30 (FIG. 4).

Each bore 20 through the extender plate 12 has a generally cylindrical configuration that is divided into two portions (FIG. 3). A first portion 22 defines a cylindrical recess that is open at the first side 14 of the extender plate 12. The first portion 22 includes a diameter larger than that of a mounting stud nut 18 such that a socket wrench (stock or impact) may be used to tighten the nut 18 and so the nut is completely recessed beneath the first side 14 when fully tightened (FIG. 4). A second portion 24 defines an opening 26 at the second side 16 having a diameter sufficient to receive a mounting stud 32 therethrough. The second portion 24 includes a configuration that is tapered between the opening 26 at the second side and the first portion 22 of the bore. The tapered configuration allows the beveled end of a nut 18 to nest therein. The first 22 and second 24 portions are in communication with one another such that a mounting stud 32 may be received therethrough. This bore configuration is preferably accomplished in a conventional counter-drilling manner.

A plurality of stud bolts 28 are attached to the first side 14 of each extender plate 12 and extend outwardly therefrom. The stud bolts 28 are arranged in a bolt circle configuration with each stud bolt 28 being positioned intermediate a respective pair of extender plate bores 20. Therefore, the diameter of the bolt circle of bores is equal to the bolt circle of stud bolts as they actually form a unitary bolt circle. This is because a vehicle wheel configured to be mounted to the vehicle wheel hub 30 is capable of being mounted to the stud bolts 28 of the extender plate 12. The stud bolts 28 are constructed in a manner substantially similar to the corresponding mounting studs 32 so as to be selectably received through the holes 40 of a hub of a vehicle wheel 38. The vehicle wheel may also be referred to as a tire/wheel combination. Conventional lug nuts 42 associated with the vehicle wheel 38 may be threadably coupled to the stud bolts 28 to secure the vehicle wheel 38 to the extender plate 12.

In use, the wheel base of a vehicle may be extended or widened by mounting an axle extension device 10 to each end of a vehicle axle 36. Thus, the axle 36 is effectively lengthened along an imaginary longitudinal axis established by a respective elongate axle 36. This may be accomplished by orienting the plurality of bores 20 of an appropriately constructed extender plate 12 with the plurality of mounting studs 32 of a vehicle wheel hub 30 and positioning the plate such that the mounting studs 32 are received through respective bores 20 (FIG. 1). The plurality of nuts 18 may then be threadably coupled to the mounting studs 32 to secure the extender plate 12 to the vehicle wheel hub 30. In like manner, the hub of a tire/wheel combination may be oriented such that the holes therein may respectively mate with the stud bolts 28 of the extender plate 12. Conventional lug nuts 42 may then be threadably coupled to the ends of the stud bolts 28 to secure the tire/wheel combination to the extender plate 12. Depending on the thickness of the particular extender plate 12, the wheel base of the vehicle may be extended by ½″ to 3″ or more at each end of an axle.

It is understood that an axle extension device 10 according to the present invention may be manufactured in various dimensions so as to be useful not only with automobiles, but also with all-terrain vehicles, dune buggies, racing vehicles, trailers, and the like. Further, it is preferred that the extender plate 12 utilize the same bolt and hole pattern of the particular vehicle wheel hub such that it is unnecessary for the vehicle owner to purchase a different tire and wheel than the one originally mounted to the vehicle hub.

It is understood that while certain forms of this invention have been illustrated and described, it is not limited thereto except insofar as such limitations are included in the following claims and allowable functional equivalents thereof.

Having thus described the invention, what is claimed as new and desired to be secured by Letters Patent is as follows:

1. An axle extension device for use with a vehicle having a plurality of wheel mounting studs arranged in a bolt circle on a vehicle wheel hub, said axle extension device comprising:
a circular extender plate defining a plurality of holes arranged in a bolt circle adapted to respectively receive said wheel mounting studs therethrough; and
said extender plate having a plurality of stud bolts arranged in a bolt circle and adapted to extend through respective holes of a hub of a vehicle wheel, each stud bolt being positioned intermediate a pair of respective extender plate holes such that said plurality of stud bolts and said plurality of extender plate holes are arranged in a unitary bolt circle.

2. The axle extension device as in claim 1 wherein said plurality of stud bolts of said extender plate and said plurality of wheel mounting studs comprise the same number of bolts and studs, respectively, whereby a vehicle wheel adapted to be mounted to a vehicle wheel hub is selectably mountable to said extender plate without adaptation.

3. The axle extension device as in claim 1 wherein said extender plate defines a width dimension that causes a vehicle wheel mounted thereto to be displaced from said vehicle wheel hub along a longitudinal axis defined by a corresponding vehicle axle.

4. The axle extension device as in claim 1 wherein a diameter of said bolt circle of said mounting studs is equal to a diameter of said bolt circle of said stud bolts, whereby a wheel adapted to be mounted to a vehicle hub is adapted to be selectably mounted to said extender plate without adaptation.

5. The axle extension device as in claim 1 further comprising a plurality of nuts adapted to threadably mate with said plurality of mounting studs when said mounting studs have been respectively received through said plurality of holes in said extender plate so as to securely mount said extender plate to said vehicle wheel hub.

6. The axle extension device as in claim 1 wherein said stud bolts on said vehicle wheel hub are adapted to mate with a plurality of lug nuts associated with said vehicle wheel when said stud bolts have been respectively received through said plurality of holes in said hub of said vehicle wheel so as to securely mount said vehicle wheel to said extender plate.

7. An axle extension device for broadening the wheel base of a vehicle having a plurality of wheel mounting studs arranged in a bolt circle on a vehicle wheel hub, said axle extension device comprising:
a circular extender plate having first and second sides and defining a plurality of bores therebetween, said bores being spaced apart and arranged in a bolt circle and adapted to respectively receive said plurality of mounting studs therethrough;
a plurality of nuts adapted to threadably mate with said plurality of mounting studs when said mounting studs are respectively received through said plurality of bores;
wherein each bore includes a cylindrical configuration and comprises:
a first portion defining an open end at said first side of said extender plate for receiving a respective nut;
a second portion having an open end at said second side of said adapter and being in communication with said first portion, said second portion having a diameter smaller than a diameter of said first portion and a configuration that is tapered to receive an end of a respective nut in said first portion having a configuration complementary to said tapered configuration; and
a plurality of stud bolts extending from said first side of said extender plate and arranged in a bolt circle, said plurality of stud bolts adapted to extend through respective holes of a hub of a tire/wheel combination.

8. The axle extension device as in claim 7 wherein said extender plate defines a width dimension that causes a tire/wheel combination mounted to said extender plate to be displaced from said vehicle wheel hub along a longitudinal axis defined by a corresponding vehicle axle.

9. The axle extension device as in claim 7 wherein said stud bolts are adapted to mate with a plurality of lug nuts associated with said tire/wheel combination when said stud bolts are respectively received through said plurality of holes in said hub of said tire/wheel combination so as to securely mount said tire/wheel combination to said extender plate.

10. The axle extension device as in claim 7 wherein each stud bolt is positioned intermediate a pair of respective bores such that said plurality of stud bolts and said plurality of bores are arranged in a unitary bolt circle.

11. The axle extension device as in claim 7 wherein said plurality of stud bolts of said extender plate and said plurality of wheel mounting studs comprise the same number of bolts and studs, respectively, whereby a tire/wheel combination adapted to be mounted to a vehicle hub is also adapted to be selectably mounted to said extender plate without adaptation.

12. The axle extension device as in claim 7 wherein a diameter of said bolt circle of said mounting studs is equal to a diameter of said bolt circle of said stud bolts, whereby a tire/wheel combination adapted to be mounted to a vehicle hub is adapted to be selectably mounted to said extender plate without adaptation.

13. An axle extension device for use with a vehicle having a plurality of wheel mounting studs arranged in a bolt circle on a vehicle wheel hub, said axle extension device comprising:
a circular extender plate defining a plurality of holes arranged in a bolt circle adapted to respectively receive said wheel mounting studs therethrough;
said extender plate having a plurality of stud bolts arranged in a bolt circle and adapted to extend through respective holes of a hub of a tire/wheel combination, each stud bolt being positioned intermediate a pair of respective extender plate holes such that said plurality of stud bolts and said plurality of extender plate holes are arranged in a unitary bolt circle;
wherein said plurality of stud bolts of said extender plate and said plurality of wheel mounting studs comprise the same number of bolts and studs, respectively, whereby a tire/wheel combination adapted to be mounted to a vehicle hub is also adapted to be selectably mounted to said extender plate without adaptation; and
wherein a diameter of said bolt circle of said mounting studs is equal to a diameter of said bolt circle of said stud bolts, whereby a tire/wheel combination adapted to be mounted to a vehicle hub is adapted to be selectably mounted to said extender plate without adaptation.

14. The axle extension device as in claim 13 wherein said extender plate defines a width dimension that causes a tire/wheel combination mounted to said extender plate to be displaced from said vehicle wheel hub along a longitudinal axis defined by a corresponding vehicle axle.

15. The axle extension device as in claim 13 wherein said stud bolts are adapted to mate with a plurality of lug nuts associated with said tire/wheel combination when said stud bolts are respectively received through said plurality of holes in said hub of said tire/wheel combination so as to securely mount said tire/wheel combination to said extender plate.
